(19) United States
(12) Patent Application Publication
(10) Pub. No.: US 2002/0129767 A1
(43) Pub. Date: Sep. 19, 2002

(54) Temperature controlled coating system

(76) Inventor: Lloyd Czerwonka, Highlands, TX (US)

Correspondence Address: Alan J. Atkinson, P.O. Box 270161, Houston, TX, 77277-0161, US

(21) Appl. No.: 09/809,530

(22) Filed: Mar. 15, 2001

(51) Int. Cl. B05C 5/00

(52) U.S. Cl. 118/667; 118/300

(57) ABSTRACT

A system for distributing liquid coatings such as epoxys and urethanes onto a substrate base. The system includes a hose for transporting the liquid coating material from a storage container to a spray gun. A heating element within the hose heats the liquid coating material to facilitate transport and distribution of the liquid coating material. The heating element contacts the liquid coating material and can be activated by electrical resistance heating or by other techniques. By placing the heating element directly in contact with the liquid coating material, long line cooling losses are avoided, and heating energy is efficiently transferred to the liquid coating material immediately before distribution. Sensors along the hose length can monitor the liquid coating material temperature at different positions, and heating control over different hose sections can be controlled to efficiently accomplish optimum liquid coating material temperature before the liquid coating material is sprayed. Two part liquid coating materials can be separately transported through distinct, internally heated hoses and combined with a mixer at a position near the spray equipment.

### BACKGROUND OF THE INVENTION

The present invention relates to the field of liquid coating materials for spraying substrate base surfaces such as concrete, metal or fiberglass. More particularly, the invention relates to an apparatus and system for heating a liquid coating material such as epoxy or urethane for transport and distribution through a hose and attached sprayer.

The invention is particularly suitable for the spraying of liquid epoxy and urethane coatings in environments handling potable water, wastewater, industrial waste, and in the secondary and primary containment of harsh chemicals. Two part epoxy and urethane coatings can provide a protective barrier in corrosive and abrasive environments and can provide physical properties and bond strengths which enhance the structural integrity of the substrate base. Certain coatings are specially designed for underwater application and for structural rehabilitation involving the inlay or encapsulation of fiberglass and chopped glass. Moisture tolerant coatings resist corrosion and erosion and provide superior bond strength when applied to moisture filled surfaces. Such coatings can furnish chemical resistance to corrosive fluids and strong solvents and can provide mechanical properties ten to twenty times higher than concrete or cementitious liners.

Typical epoxy coatings are self-priming and provide exceptional bonding to concrete, brick, steel, fiberglass and other surfaces. Epoxy coatings can comprise one hundred percent solids containing zero solvents or VOCs. The cured, finish product is virtually inert and is rated for contact with potable water and food handling systems. Epoxy coatings can provide “high-build” surfaces up to 250 mils thick and cure rapidly to reduce down service time.

Heated spray systems have been developed to mix and distribute two part epoxy coatings. Various temperature control systems have been developed to control viscosity and spray distribution in painting and coating processes. U.S. Pat. No. 3,880,228 to Houk et al. (1975) disclosed a method and apparatus for heating paint to control paint viscosity. A heat exchange vessel provided a heat exchange zone for controlling the heating of a paint stream. U.S. Pat. No. 5,439,714 to Mori et al. (1995) disclosed a thermal spray bending member having an inclined guide plate for controlling the distributing of spray material distribution. Other systems heat the paint storage pots so that the coating material is preheated before distribution.

Liquid epoxy coatings are formed by mixing two part components of thick, viscous hardener and resin. Such components cannot be thinned with solvents because the final coating will be susceptible to pinholes and loss of adhesion. Consequently, drum heaters and heater wire wrapped hoses are used to reduce the liquid epoxy viscosity. Although liquid epoxy coatings are thermosetting and generate heat after the resin and hardener are mixed, heat losses in long distribution hoses significantly offset any heat internally generated.

Conventional liquid epoxy distribution systems initially heat the resin and hardener in separate storage pots. A plural component airless sprayer system mechanically mixes the heated resin and hardener and pumps the components to a mixing block and tubes. The resin and hardener are homogeneously blended and the resulting liquid epoxy is pumped through a whip hose to an airless or air assisted spray gun. In long hoses, resistance heating wires are wrapped around the hose exterior to heat the liquid epoxy flowing through the hose interior. In cold weather and in long hose runs, such heating wires cannot transfer sufficient heat to the liquid epoxy to permit liquid epoxy spraying. Although the resistance wire size can be increased to raise the current flow and heat transfer heater wire capability, this approach wastes energy and increases the total size and mass of the hose assembly. Additionally, such approach does not provide control over the liquid epoxy temperature at different positions within an extended hose length.

Accordingly, a need exists for an improved apparatus and system for heating a liquid coating material so that the liquid coating material can be transported and distributed through a sprayer or other mechanism.

### SUMMARY OF THE INVENTION

The present invention provides an improved apparatus and system for distributing a liquid coating material. The apparatus comprises a hollow hose having a first end for receiving the liquid coating material and a second end for discharging the liquid coating material, a thermal wire in contact with the liquid coating material within the hose, and a heating means engaged with the thermal wire for heating the thermal wire and the liquid coating material in contact with the wire. In other embodiments of the invention, the thermal wire can be heated with electrical resistance heating, a sensor can detect the liquid coating material temperature at different locations along the hose, and the thermal wire can be attached to the hose inner wall or can be integrated within the hose. For two part liquid coating materials, a separate thermal wire can be integrated with each supply hose leading to a common mixing block.

The invention also provides a system for distributing a liquid coating material to a substrate base comprising a hose, a sprayer for receiving the liquid coating material from the hose and for spraying the liquid coating material onto the substrate base, a thermal wire in contact with the liquid coating material within the hose, and a heating means engaged with the thermal wire for heating the thermal wire and the liquid coating material in contact with the thermal wire.

### BRIEF DESCRIPTION OF THE DRAWINGS

FIG. 1 illustrates a partial sectional view of a thermal wire within a hose.

FIG. 2 illustrates an end view of two thermal wires attached to the interior hose wall.

FIG. 3 illustrates a sectional view of a thermal wire integrated within a hose and in contact with the liquid coating material.

FIG. 4 illustrates an elevation view of a system for distributing liquid coating material to a substrate base.

FIG. 5 illustrates a system for transporting and distributing a two part liquid coating system.

### DESCRIPTION OF THE PREFERRED EMBODIMENTS

The invention provides a unique apparatus and system for heating liquid coating material which significantly enhances the spray distribution of the liquid coating material. The invention accomplishes this functional result by significantly improving the heat transfer capabilities in a spray distribution hose or hose pair.

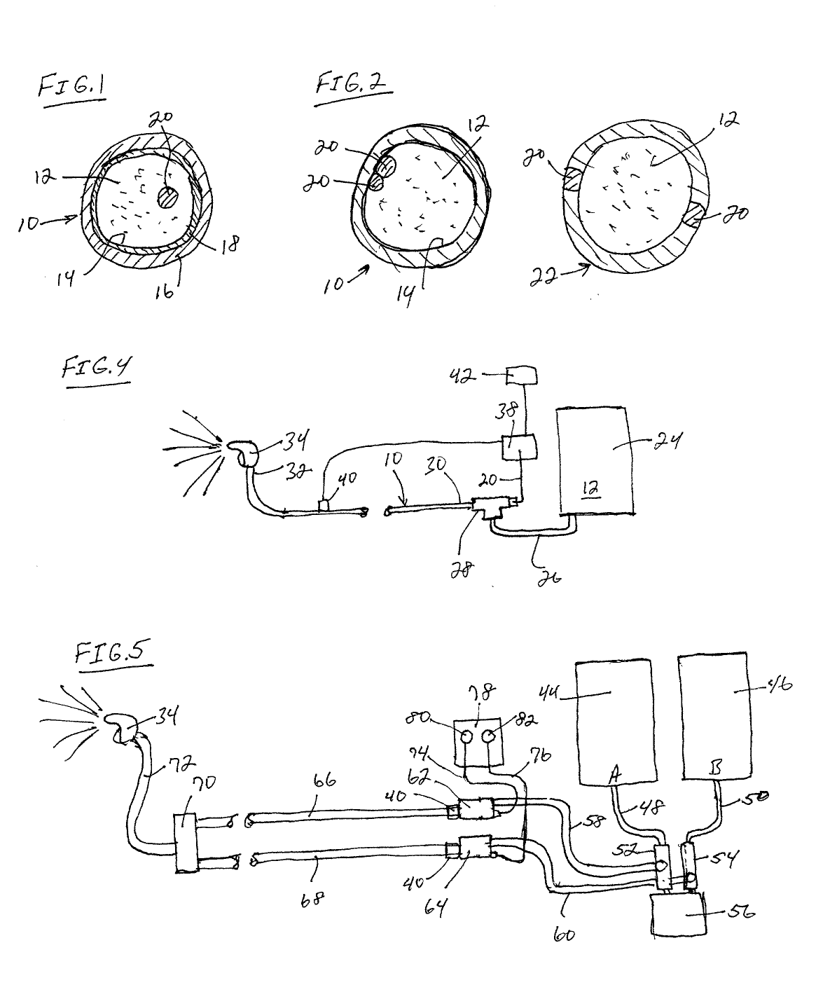

FIG. 1 illustrates one embodiment of the invention wherein hollow distribution hose 10 transports liquid coating material identified as epoxy 12. Although references to “epoxy” are used herein, the invention is suitable to urethanes and other liquid materials, and is particularly useful for the transport and distribution of two part coating materials. Hose 10 has interior wall 14 in contact with liquid epoxy 12 and is typically formed with braided stainless steel 16 and hose liner 18 formed with Teflon® or other suitable material. One or more thermal wires 20 extend through the interior of hose 10 and are in contact with liquid epoxy 12.

As used herein, the term “thermal wire” is defined as any structure or element capable of distributing thermal energy to epoxy 12. Although a preferred embodiment of the invention uses electrical resistance heating through an electricity conductive wire, thermal wire 20 can comprise a tubing carrying a heated fluid, a radiation source, an exothermal chemical reaction, or other heat generation mechanism. For electrical resistance wires, thermal wire 20 comprises an electrode for transferring thermal energy to epoxy 12. Although one thermal wire 20 is illustrated in FIG. 1, more than one thermal wire 20 or combination of thermal wires 20 can be independently run through hose 10 or collectively run in a bundle through hose 20 interior.

As liquid epoxy 12 is transported through the interior of hose 10, thermal wire 20 selectively transmits heat directly to liquid epoxy 12. This unique feature of the invention efficiently transfers heat and reduces environmental heat losses. This feature of the invention also reduces wear and damage to thermal wire 20 by encasing thermal wire 20 within the protective casing provided by hose 10. Although conventional heating strips enlarge the outside diameter of the hose bundle and are subject to wear and other environmental contact damage, the present invention overcomes these limitations of prior art heating systems.

Thermal wire 20 can be removed from the interior of hose 10 to permit inspection, repair and replacement of thermal wire 20 or interior wall 14. Such removal also facilitates any desired cleaning of the interior of hose 10. Thermal wire 20 can be insulated or uninsulated, depending on the particular application.

Encasing thermal wire 20 also provides other structural advantages not possible within conventional heating systems. Because the internal placement of thermal wire 20 provides maximum efficiency in heat transfer to liquid epoxy 12 by contacting epoxy 12 around the entire circumference of thermal wire 20, the size of thermal wire 20 can be downsized to the smallest necessary conductor size for the resistance heating desired. This feature reduces the overall hose cross-section, reduces the cost of thermal wire 20, simplifies the construction of the entire hose bundle, and maximizes the flow area within the interior of hose 10 which is not displaced by thermal wire 20.

The invention is particularly suitable for liquid coating materials such as urethanes and epoxys formed with two part resin and hardener components. A representative supply of epoxy coatings are distributed by Raven Lining Systems of Tulsa Okla., and include ultra high-build epoxy systems which are self-priming and provide excellent bonding to concrete, brick, steel and other surfaces. The thixotropic characteristics of such coatings permit the coatings to be sprayed, wiped, brushed, or rolled on horizontal, vertical or overhead surfaces to provide an impermeable resistant topping. Such coatings are moisture tolerant and can be applied at single coat thicknesses varying from 8 to 250 mils. Liquid epoxy coatings do not contain known carcinogens, mutagens or teratogens classified as hazardous substances, heavy metals, pesticides or toxic substances, and do not cause adulteration of food products. The cured coating can withstand daily cleaning, cyclical temperature changes, and wet environmental conditions.

Surface preparation is important to enhance adhesion for such coatings, and a clean, porous base surface is preferred. Oil, grease, rust, latent concrete and other surface contaminants can be removed with high pressure water cleaning, sand blasting, shot blasting, hand tooling or bush hammering, or chemical cleaning. New concrete should be cured 10-28 days and should be free of form release, curing compounds, toppings, waxes, and grease, and cracks or fissures should be filled with a quick setting cementitious mortar or high strength epoxy grout. Scale and soluble salts should be removed from steel surfaces.

Liquid epoxy coatings typically comprise two component 100% solids amine cured epoxy systems which combine fixed ratios of resin to hardener to provide the finish product. The handling characteristics and curing time of such thermosetting systems are affected by the temperature and the surface temperature of the substrate base. Faster curing will occur as the temperature of the components, substrate base or environment increase. To avoid outgassing through the substrate base, the coating is preferably applied to the substrate base when the sunlight does not directly impact the substrate base surface.

For a Raven epoxy coating identified as AquataPoxy A-6TM, one-part resin is mixed with one-part hardener by volume. The viscosity of the unheated resin typically ranges between 10-18,000 cps, Brookfield RVF, #6 spindle at 10 rpm, 9.9 +/− 0.3 pounds per gallon, and the viscosity of the hardener ranges between 80-140,000 cps, Brookfield RVF, #7 spindle at 10 rpm, 13.3 +/− 0.3 pounds per gallon. The mixture is 11.6 +/− 0.3 pounds per gallon. The flexural strength of the finish coating is 8,030 psi, the flexural modulus is 790,000 psi, the compressive strength (yield) is 4,175 psi, the tensile strength is 2,700 psi, and the tensile ultimate elongation is 3.4%. The Shore D hardness is 87, the Pencil hardness is 4H, and the temperature resistance is rated to 200 degrees F.

The pot life and working life of the epoxy coatings is affected by temperature, coating thickness or mass, and by the presence of an aggregate or heat sink. The cure and set time of the epoxy coating increases at higher temperatures and can be enhanced to facilitate spray distribution and to accelerate the cure time. Unlike evaporative points where thinner paint dries faster than thicker layers, thermosetting materials cure at a rate inversely proportional to the coating thickness. If the coating mass and thickness increases, more heat is generated and the set time is shortened.

Recommended application thicknesses are 80-100 mils for new or smooth concrete, 100-125 mils for rough concrete, 100-150 mils for masonry and brick, 60-80 mils for steel, and 40-60 mils for fiberglass substrates. A wet film thickness gauge should be used verify monolithic coating and uniform coating thickness, and ultrasonic thickness gauge, destructive testing, or holiday testing can be performed after the coating is hard to the touch. High voltage holiday detection equipment can set a spark tester at 100 volts per one mil of film thickness, and detected holidays can be marked and repaired according to manufacturer specifications. Other tests can be performed to verify the coating performance for evidence of pinholes, blisters, and evenly distributed coloring, proper mix ration, coverage and cure. Epoxy coatings can generally be returned to service when the coating is hard to the touch, typically after four to eight hours when applied at 60 mils at 70 degrees F. For severe corrosion duty such as high concentrate acids or caustics or solvents, three to seven days of cure time, or forced curing may be necessary before the coating is placed in service.

Liquid coating material systems have been successfully applied to manhole rehabilitation projects, sanitary sewer force mains and manhole sanitary sewer corrosion repairs, concrete collection boxes in corrosive industrial wastewater from pulp and paper mills, high pressure regulation vaults, tunnels, lift stations, power plant tank linings, fish hatchery rehabilitations, and water tanks.

FIG. 2 illustrates another embodiment of the invention wherein two thermal wires 20 are attached to interior wall 14 of hose 10. Such attachment can be permanent or can be temporary to permit the withdrawal and replacement of thermal wires 20. As in the FIG. 1 embodiment, thermal wires 20 contact liquid epoxy 12 to facilitate heat transfer between thermal wires 20 and liquid epoxy 12.

FIG. 3 illustrates another embodiment of the invention wherein two thermal wires 20 are integrated within a casing to form integrated hose 22. Thermal wires 20 contact liquid epoxy 12 to provide the heat transfer capabilities previously described without impeding fluid flow through the interior of hose 22. Although thermal wires 20 are illustrated as separately integrally strands, part or all of a structural element for hose 22 could be electrified to provide electrical resistance heating for liquid epoxy 12. In this embodiment, an outer, electrically nonconductive insulation layer could form the “hose” component of the invention, and the inner structural tubing or braided element could form the “thermal wire”.

FIG. 4 illustrates one system utilizing the principles of the invention. Storage container 24 retains liquid epoxy 12 and is connected with supply line 26 and fitting 28. Hose 10 has first end 30 attached to fitting 28 to receive liquid epoxy 12 and has second end 32 attached to spray gun 34 for distributing particles of liquid epoxy onto the selected substrate base. Thermal wire 20 enters hose 10 at fitting 28, and entry is provided through attachment 36. Thermal wire 20 is attached to a heating means such as electrical supply 38 which provides electricity to thermal wire 20 for electrical resistance heating of thermal wire 20 and liquid epoxy 12. Sensor 40 is attached to hose 10 to detect and to monitor the temperature of liquid epoxy 12 at a selected location within hose 10. The flash point for epoxy materials is typically around 200 degrees F, and one or more sensors 40 can be placed to monitor the mixture temperature inline of the liquid epoxy application system to provide a safety mechanism for preventing overheating of liquid epoxy 12. If the safe temperature of liquid epoxy 12 is exceeded, sensor 40 can communicate with electrical supply 38 to reduce the amount of electricity supplied, or to terminate all electricity provided.

In other embodiments of the invention, more than one thermal wire 20 can be located at different sections along the length of hose 10. This feature of the invention recognizes that heat losses along hose 10 become more important as the length of hose 10 and corresponding distance from mixer 30 increases. Each thermal wire 20 or selected section of thermal wire 20 can be selectively heated with electrical supply to vary the thermal energy released to liquid epoxy 12 at different positions along hose 10. If desired, controller 42 can be engaged with electrical supply 30 to monitor the temperature information detected by different sensors 40, to control the operation of electrical supply 38, and to control the distribution and release of thermal energy along different sections of hose 10.

FIG. 5 illustrates another embodiment of the invention wherein a liquid coating material transport and distribution system is disclosed. Storage cylinders 44 and 46 provide two part components A and B such as the resins and hardeners typically used in epoxy coating materials. Cylinders 44 and 46 can comprise 55 gallon drums or specialized storage tanks or containers. Supply lines 48 and 50 are connected with pressure cylinders 52 and 54 powered with pump 56 to pressurize components A and B. Pressure supply lines 58 and 60 are connected with fittings 62 and 64 respectively, which in turn are connected to temperature sensors 40 attached to hoses 66 and 68 respectively. Hoses 66 and 68 each transport one of components A or B to mixing block 70, wherein components A and B are mixed and supplied through whip hose 72 to spray gun 34.

Thermal wire 74 enters hose 66 through fitting 62 and extends from control box 76 substantially throughout the entire length of hose 66. Thermal wire 76 enters hose 68 through fitting 64 and extends from control box 78 substantially throughout the entire length of hose 68. Thermal wire 74 is connected with temperature controller 80, and thermal wire 76 is connected with temperature controller 82 within control box 78. Temperature controllers 80 and 82 are each connected with separate temperature sensors 40 which detect the operating temperature at the first ends of hoses 66 and 68, and transmit a signal representative of such temperatures to temperature controllers 80 and 82. The temperature for each electrode or thermal wire can be selected depending on the viscosity or initial temperature of components A and B. For example, component A could be heated with thermal wire 74 to 250 degrees F, and component B could be independently heated with thermal wire 76 to 100 degrees F. The invention provides unique flexibility in selectively heating one or two components to a desired temperature, thereby maintaining control over the transport and spray distribution of the liquid coating material.

The invention permits the hose length to extend far beyond the reach of conventional hoses. This feature of the invention is important in the field applications where the storage drums or containers cannot be positioned near the surfaces to be coated, and where safety considerations require safe working distances. The invention permits hose lengths hundreds of meters long, which was not feasible with conventional hose systems. The invention accomplishes this function by significantly increasing the efficiency of heat transfer from a thermal wire to the liquid coating material or component. The invention also accomplishes this function by permitting the heating of selected hose sections independently of the other hose sections.

Although the invention has been described in terms of certain preferred embodiments, it will become apparent to those of ordinary skill in the art that modifications and improvements can be made to the inventive concepts herein without departing from the scope of the invention. The embodiments shown herein are merely illustrative of the inventive concepts and should not be interpreted as limiting the scope of the invention.

What is claimed is:

1. An apparatus for distributing a liquid coating material, comprising;
a hollow hose having a first end for receiving the liquid coating material and a second end for discharging the liquid coating material;
a thermal wire in contact with the liquid coating material within said hose; and
heating means engaged with said thermal wire for heating said thermal wire and the liquid coating material in contact with said thermal wire.

2. An apparatus as recited in claim 1, wherein said thermal wire extends continuously between the first and second ends of said hose.

3. An apparatus as recited in claim 1, wherein said thermal wire is located within the interior portion of said hose.

4. An apparatus as recited in claim 1, wherein said hose has an interior wall, and wherein said thermal wire is attached to the said hose interior wall.

5. An apparatus as recited in claim 4, wherein said thermal wire is integrated within said hose interior wall for contacting the liquid coating material.

6. An apparatus as recited in claim 1, further comprising a sensor in contact with the liquid coating material for detecting the liquid coating material temperature.

7. An apparatus as recited in claim 6, wherein said sensor is engaged with said heating means for communicating the liquid coating material temperature to said heating means, and wherein said heating means is capable of adjusting the temperature of the said thermal wire in contact with the liquid coating material.

8. An apparatus as recited in claim 7, wherein said heating means is capable of adjusting the thermal wire temperature at selected positions along the length of said thermal wire.

9. An apparatus as recited in claim 1, wherein said heating means is capable of selectively heating a portion of said thermal wire.

10. An apparatus as recited in claim 1, wherein said thermal wire comprises an electrical conductor heatable by the electrical resistance of said thermal wire when said heating means flows electricity through said thermal wire.

11. An apparatus as recited in claim 10, wherein said thermal wire comprises at least two strands heatable with electrical resistance heating.

12. A system for distributing a liquid coating material to a substrate base, comprising;
an elongated, hollow hose having a first end for receiving the liquid coating material and a second end for discharging the liquid coating material;
a sprayer for receiving the liquid coating material from said hose second end and for spraying the liquid coating material onto the substrate base;
a thermal wire in contact with the liquid coating material within said hose; and
heating means engaged with said thermal wire for heating said thermal wire and the liquid coating material in contact with said thermal wire.

13. A system as recited in claim 12, further comprising a heated storage container for supplying the liquid coating material to said hose first end.

14. A system as recited in claim 12, wherein said liquid coating material is formed with two components initially stored in separate containers, two hoses separately transport the two components to a mixer proximate to said sprayer, and a separate thermal wire is positioned within each hose to separately heat each of said components.

15. A system as recited in claim 12, wherein said thermal wire is heatable by passing electricity through said thermal wire, and wherein said heating means is capable of distributing electricity through said thermal wire.

16. A system as recited in claim 12, further comprising a pump for pressurizing the liquid coating material.

17. A system as recited in claim 12, wherein said thermal wire is attached to an interior wall of said hose.

18. A system as recited in claim 12, wherein said thermal wire is integrated into to said hose for contacting the liquid coating material.

19. A system as recited in claim 12, wherein said thermal wire is removable from within said hose interior.

20. A system as recited in claim 12, further comprising a sensor for detecting the liquid coating material temperature, wherein said sensor is engaged with said heating means for controlling the temperature of said thermal wire in response to the detected temperature of the liquid coating material.
